(19) United States
(12) Patent Application Publication
(10) Pub. No.: US 2022/0352590 A1
(43) Pub. Date: Nov. 3, 2022

(54) BATTERY PACK WITH REINFORCED LATCH ARRANGEMENT

(71) Applicant: MILWAUKEE ELECTRIC TOOL CORPORATION, Brookfield, WI (US)

(72) Inventors: Richard M. SEBZDA, Wauwatosa, WI (US); Gurusiddeshwar GUDIMANI, Plymouth, WI (US); Cameron R. SCHULZ, Milwaukee, WI (US); John G. MARX, Hartford, WI (US); Jin Cai LI, Dongguan City (CN)

(21) Appl. No.: 17/733,631

(22) Filed: Apr. 29, 2022

(30) Foreign Application Priority Data
Apr. 30, 2021 (CN) 202110482437.3

(51) Int. Cl. H01M 50/262; H01M 50/247; B25F 5/02

(52) U.S. Cl. CPC H01M 50/262; H01M 50/247; B25F 5/02

(57) ABSTRACT

A battery pack includes at least one battery cell configured to provide electrical power to a device, a housing configured to receive the at least one battery cell, a latch cantilevered on the housing and configured to couple the battery pack to the device, an actuator configured to move the latch toward a release position in which the latch is configured to release the battery pack from the device, and a latch insert. At least one of the latch or the actuator is at least partially molded over the latch insert.

### BACKGROUND

The present disclosure relates to a battery pack, such as a battery pack for an electrical device and/or a power tool. The battery pack includes a latch arrangement for coupling the battery pack to the electrical device and/or the power tool.

### SUMMARY

In a first aspect, the disclosure provides a battery pack. The battery pack includes at least one battery cell configured to provide electrical power to a device, a housing configured to receive the at least one battery cell, a latch cantilevered on the housing and configured to couple the battery pack to the device, an actuator configured to move the latch toward a release position in which the latch is configured to release the battery pack from the device, and a latch insert. At least one of the latch or the actuator is at least partially molded over the latch insert.

In one implementation of the first aspect, the latch insert is at least partially disposed in the latch only. In another implementation of the first aspect, the latch insert is at least partially disposed in the actuator only. In yet another implementation of the first aspect, the latch insert is at least partially disposed in the latch and the actuator.

In one implementation of the first aspect, the latch and the actuator are at least partially molded over the latch insert.

In one implementation of the first aspect, the housing includes a stem portion configured to receive the at least one battery cell and insertable into a receptacle in the device for electrical connection therewith. The housing includes a latch portion. The actuator is cantilevered on the latch portion. The latch is cantilevered from the actuator. In the release position the actuator is flexed towards the stem portion.

In one implementation of the first aspect, the actuator includes a grip surface disposed externally and configured for manual actuation by a user.

In one implementation of the first aspect, the latch includes a shaft and a catch projecting transverse to the shaft, wherein at least one of the shaft or the catch is at least partially molded over the latch insert.

In one implementation of the first aspect, the latch insert is at least partially disposed in at least one of the shaft or the catch.

In one implementation of the first aspect, the latch insert includes a shaft portion disposed in the shaft and a catch portion disposed in the catch.

In one implementation of the first aspect, the latch insert includes an aperture disposed in at least one of the shaft portion or the catch portion.

In one implementation of the first aspect, the aperture is disposed in both the shaft portion and the catch portion, through a bend in the latch insert.

In one implementation of the first aspect, the shaft portion is substantially planar. The catch portion is substantially planar.

In one implementation of the first aspect, the shaft portion and the catch portion are disposed at a substantially right angle.

In one implementation of the first aspect, the shaft portion and the catch portion are connected by a single bend in the latch insert.

In one implementation of the first aspect, the shaft portion and the catch portion are connected by a first bend in the latch insert. The shaft portion includes a second bend in the latch insert. The second bend divides the shaft portion into a first generally planar portion and a second generally planar portion offset from, and generally parallel to, the first generally planar portion.

In one implementation of the first aspect, the first generally planar portion and the catch portion include an elongated aperture passing through the first bend. The second generally planar portion includes a plurality of apertures configured to receive a flow of material molded therein.

In one implementation of the first aspect, the latch insert is formed from a rigid material and is more rigid than a material of the latch and/or more rigid than a material of the actuator.

In one implementation of the first aspect, the actuator and the latch are formed as one piece from a flow of material in a molding operation.

In one implementation of the first aspect, the actuator and the latch are formed from a polymeric material and the latch insert is formed from a metal.

In a second aspect, the disclosure provides a battery pack. The battery pack includes a plurality of battery cells configured to provide electrical power to a device, a housing configured to receive the plurality of battery cells, a latch configured to flex to couple the battery pack to the device, and an actuator configured to move the latch toward a release position in which the latch is configured to release the battery pack from the device. The actuator is cantilevered on the housing, and the latch is cantilevered from the actuator. The battery pack also includes a latch insert. At least one of the latch or the actuator is at least partially molded over the latch insert.

In one implementation of the second aspect, the latch insert is at least partially disposed in the latch only. In another implementation of the second aspect, the latch insert is at least partially disposed in the actuator only. In yet another implementation of the second aspect, the latch insert is at least partially disposed in the latch and the actuator.

In one implementation of the second aspect, the actuator and the latch are formed as one piece from a flow of material in a molding operation

In a third aspect, the disclosure provides a battery pack. The battery pack includes a plurality of battery cells configured to provide electrical power to a device, a housing configured to receive the plurality of battery cells, a latch configured to flex to couple the battery pack to the device, and an actuator configured to move the latch toward a release position in which the latch is configured to release the battery pack from the device. The actuator is cantilevered on the housing, and the latch is cantilevered from the actuator. The actuator and the latch are formed as one piece from a flow of material in a molding operation. The battery pack also includes a latch insert. At least one of the latch or the actuator is at least partially molded over the latch insert. The latch insert is formed from a rigid material and is more rigid than the material of the latch and the actuator.

In one implementation of the third aspect, the latch insert is at least partially disposed in the latch only. In another implementation of the third aspect, the latch insert is at least partially disposed in the actuator only. In yet another implementation of the third aspect, the latch insert is at least partially disposed in the latch and the actuator.

In one implementation of the third aspect, the latch includes a shaft extending generally in a direction of insertion of the battery pack into the device and a catch projecting from the shaft transverse to the direction of insertion proximate a distal end of the shaft. The latch insert is disposed in the shaft and the catch.

Other aspects of the invention will become apparent by consideration of the detailed description and accompanying drawings. Any feature(s) described herein in relation to one aspect, implementation, or implementation may be combined with any other feature(s) described herein in relation to any other aspect, implementation, or embodiment as appropriate and applicable.

### BRIEF DESCRIPTION OF THE DRAWINGS

FIG. 1 is a perspective view of a battery pack embodying the disclosure.

FIG. 2 is the same perspective view of the battery pack of FIG. 1 having a portion of the housing illustrated as transparent.

FIG. 3 is another perspective view of the battery pack of FIG. 1 having a portion of the housing illustrated as transparent.

FIG. 4 is the same perspective view of the battery pack of FIG. 3 having portions of the housing removed to illustrate the cells.

FIG. 5 is an enlarged view of the battery pack of FIG. 4 having the cells removed to illustrate the latches.

FIG. 6 is a perspective view of a latch insert according to the implementation of FIG. 1.

FIG. 7 is an enlarged perspective view of a latch with the latch being illustrated as transparent to illustrate the latch insert.

FIG. 8 is a perspective view of another implementation of a portion of the housing embodying the disclosure.

FIG. 9 is the same perspective view of the portion of the housing of FIG. 8 illustrated as partially transparent.

FIG. 10 is a perspective view of a latch insert according to the implementation of FIG. 8.

Before any implementations of the disclosure are explained in detail, it is to be understood that the disclosure is not limited in its application to the details of construction and the arrangement of components set forth in the following description or illustrated in the following drawings. The disclosure is capable of other implementations and of being practiced or of being carried out in various ways. Also, it is to be understood that the phraseology and terminology used herein are for the purpose of description and should not be regarded as limiting. The terms “approximately”, “about”, “generally”, “substantially”, and the like should be understood to mean within standard tolerances as would be understood by one of ordinary skill in the art.

### DETAILED DESCRIPTION

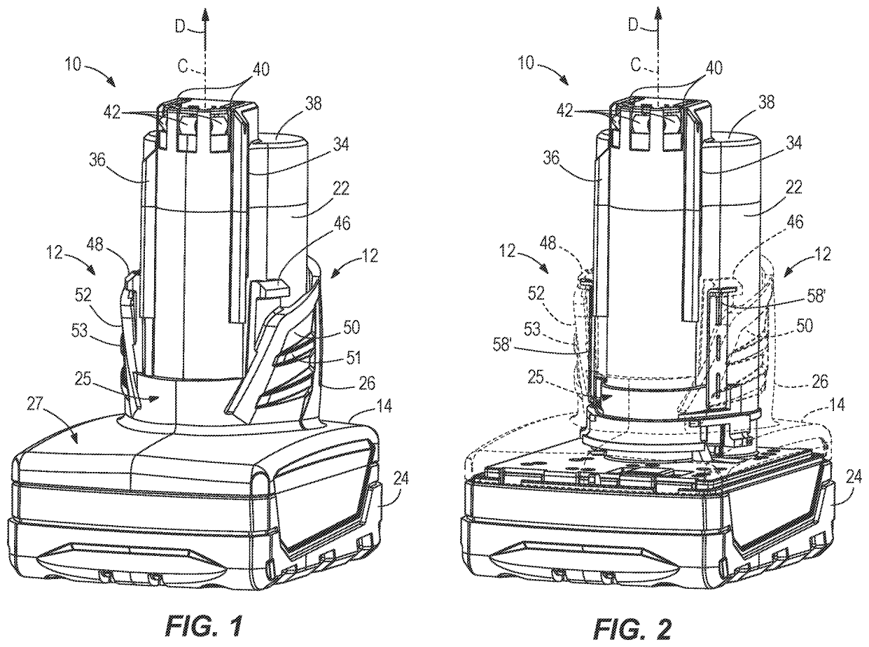

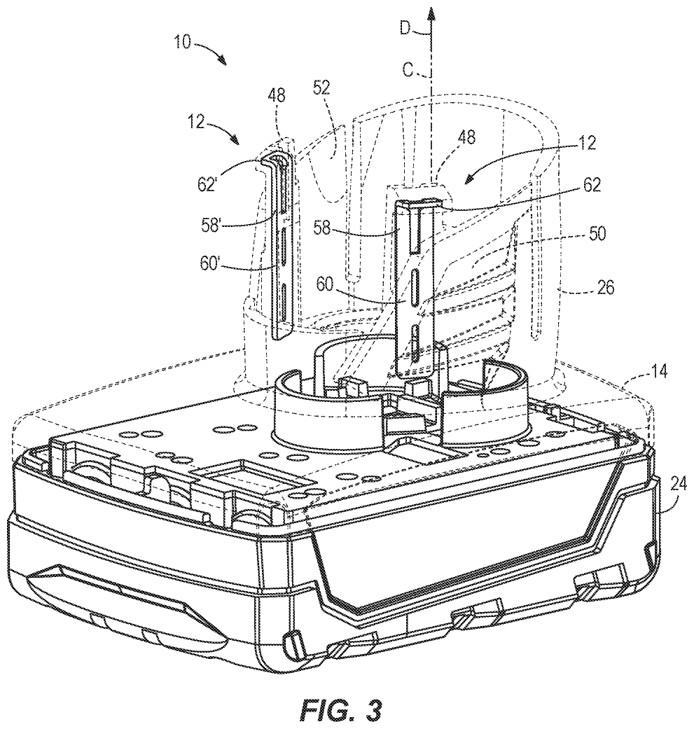

FIGS. 1-7 illustrate a battery pack 10 having a latch arrangement 12 for coupling the battery pack 10 to a device, such as an electrical device and/or a power tool (not shown). The device (not shown) may include a drill, an impact driver, a ratchet, a reciprocating saw, an oscillating multi-tool, a meter, an imaging device, an inspection device, a detection device, a light, or the like. The battery pack 10 includes a housing 14 including a stem portion 22, a base portion 24, and a latch portion 26. The housing 14 may be formed from any number of pieces joined together in any suitable fashion, removably or fixedly, in any combination. In other implementations, the housing 14 may have other shapes, arrangements, configurations, etc. For example, the housing 14 need not include a stem portion 22.

The housing 14 is formed from a material, such as a polymeric material, such as plastic and/or elastomer, by any suitable polymer manufacturing method. For example, the housing 14 material may include one of, or a combination of any one or more of, Polycarbonate (PC), Polypropylene (PP), Nylon, Acrylonitrile Butadiene Styrene (ABS), PC-ABS, Glass filled Polypropylene, and/or Nylon. For example, the housing 14 may be molded (formed from a flow of the material in a molding operation), e.g., by plastic injection molding, insert molding, blow molding, compression molding, overmolding, or any other suitable molding method. In yet other implementations, the housing 14 may be formed from other manufacturing methods.

Each portion of the housing 14 (e.g., the stem portion 22, the base portion 24, and the latch portion 26) may be formed as separate pieces from separate molding operations. In other implementations, any combination of one or more of the stem portion 22, the base portion 24, and the latch portion 26 may be formed as a single piece.

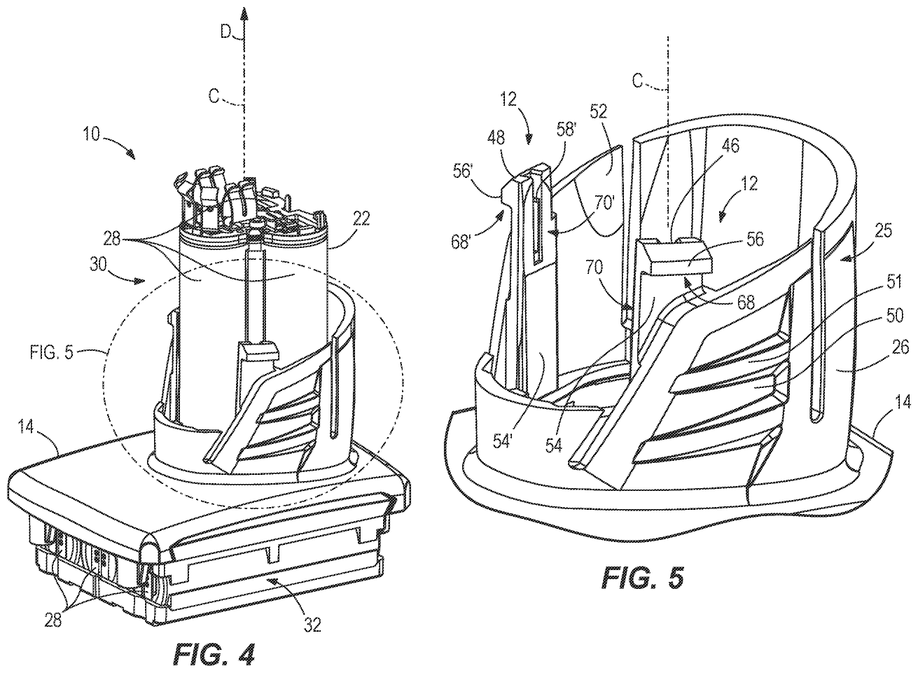

The battery pack 10 includes a plurality of battery cells 28 (FIG. 4) housed in the housing 14. The plurality of battery cells 28 may be arranged in any suitable configuration and may include any number of battery cells 28. In the illustrated implementation, the plurality of battery cells 28 include a first group of cells 30 housed in the stem portion 22 and a second group of cells 32 housed in the base portion 24. The first group of cells 30 includes three battery cells 28, and the second group of cells 32 includes three battery cells 28, though other cell quantities may be employed, such as one, two, four, or more. In the illustrated implementation, the battery pack 10 is a lithium-based, rechargeable battery pack 10 and is removably and interchangeably connectable to the device (not shown) to provide power during operation and to facilitate recharging of the battery pack 10 when not in use. The battery cells 28 may be arranged in series, in parallel, or a series and parallel combination. Each battery cell may have a nominal voltage of approximately four-volts (4.0V). In other implementations, each battery cell may have other nominal voltages, such as approximately 3.6V, 3.8V, 4.2V, etc., or more, or any other nominal voltage depending on the individual nominal voltage and arrangement of the battery cells 28. The battery pack 10 may have a nominal voltage of approximately 10.8V, 12V, 14.4V, etc., or more. The battery cells 28 may each have a capacity rating of approximately 1.2 Ah, 1.3 Ah, 1.4 Ah, 2.0 Ah, 2.4 Ah, 2.6 Ah, 3.0 Ah, etc., or more. The battery pack 10 may have a capacity rating of approximately 2.4 Ah, 2.6 Ah, 2.8 Ah, 4.0 Ah, 5.2 Ah, 6.0 Ah, etc., or more, or any other capacity rating depending on the number and configuration of battery cells 28 employed. In the illustrated implementation, the battery cells 28 are lithium-ion battery cells having a chemistry of, for example, lithium-cobalt (Li—Co), lithium-manganese (Li—Mn), or Li—Mn spinel, etc. In other implementations, the battery cells 28 may have other suitable lithium or lithium-based chemistries. In yet other implementations, the battery cells 28 may have non-lithium-based chemistries.

The stem portion 22 is shaped and sized to fit within a receptacle (not shown) in the device (not shown). Thus, the first group of cells 30 is received within a housing of the device (not shown) when the battery pack 10 is inserted therein. The stem portion 22 includes a first elongated projection 34 and a second elongated projection 36 (FIGS. 1-2) extending in a direction of insertion D of the battery pack 10 into the device (not shown). The first and second elongated projections 34, 36 provide for keyed insertion into the receptacle (not shown) in a single orientation and center the battery pack 10 in the receptacle (not shown). In other implementations, the stem portion 22 may have any number of elongated projections, such as one, three, or more. The stem portion 22 may have any suitable shape and configuration.

With further reference to FIGS. 1-2, the stem portion 22 includes an end cap 38 to substantially enclose the first group of cells 30 within the stem portion 22. The illustrated end cap 38 includes two power terminals 40 configured to provide electrical power, though any number of power terminals may be employed in other implementations. The end cap 38 also includes sense or communication terminals 42 coupled to a battery circuit (not shown). The battery circuit (not shown) may be configured to monitor various aspects of the battery pack 10, such as pack temperature, pack and/or cell state of charge, etc. and may also be configured to send and/or receive information and/or commands to and/or from the device (not shown).

The latch portion 26 includes the latch arrangement 12 and a generally tube-shaped structure 25 extending from a generally rectangular base 27 (FIG. 1). The generally tube-shaped structure 25 defines a central axis C that is generally parallel with the direction of insertion D. The latch arrangement 12 extends in the direction of insertion D, generally parallel to the central axis C. The generally rectangular base 27 at least partially encloses the second group of cells 32 in cooperation with the base portion 24. At least the generally tube-shaped structure 25 and the latch arrangement 12 are formed as one piece from the flow of material in the molding operation. In the implementation of FIGS. 1-5, the generally tube-shaped structure 25, the latch arrangement 12, and the generally rectangular base 27 are formed as one piece from the flow of material in the molding operation.

The latch arrangement 12 is cantilevered on the generally tube-shaped structure 25 of the latch portion 26. The latch arrangement 12 includes first and second latches 46, 48 for coupling the battery pack 10 to the device (not shown), and first and second actuators 50, 52 for releasing the respective first and second latches 46, 48. In other implementations, any number of latches and actuators may be employed, such as one of each, three of each, four of each, or more. The first and second latches 46, 48 releasably secure the battery pack 10 to the device (not shown), and the first and second actuators 50, 52 allow a user to release the battery pack 10 from the device (not shown) by pressing inwards or squeezing a grip surface 51, 53, respectively, of the first and second actuators 50, 52. Each grip surface 51, 53 is disposed externally (on an outer surface of the battery pack 10) and configured for manual actuation by the user. Actuating (e.g., depressing) the first and second actuators 50, 52 moves or flexes the respective first and second latches 46, 48 toward a release position configured to release the battery pack 10 from the device. Specifically, in the illustrated implementation, the release position of the first and second latches 46, 48 is realized as flexion of the first and second latches 46, 48 toward the stem portion 22 (e.g., toward each other) such that the battery pack 10 may be pulled out of engagement with the device (not shown). Such an arrangement allows the user to quickly remove the battery pack 10 for recharging or replacement without the use of tools.

The first latch 46 will be described in greater detail below, and it should be understood that the detailed description of the first latch 46 also applies to the second latch 48 such that the second latch 48 need not be described separately herein. Accordingly, the same reference numerals that are used to describe the first latch 46 below are also used in the drawings on the second latch 48 followed by “′”. The detailed description of the first latch 46 may also apply to any number of latches that may be employed.

The first latch 46 is cantilevered on the latch portion 26 of the housing 14. More specifically, the first latch 46 is cantilevered from the first actuator 50, and the first actuator 50 is cantilevered from the generally tube-shaped structure 25. Specifically, at least the first actuator 50 and the first latch 46 are formed as one piece from the flow of the material of the latch portion 26 in the molding operation. More specifically, the first latch 46, the first actuator 50, and the generally tube-shaped structure 25 are formed as one piece from the flow of the material of the latch portion 26 in the molding operation. Even more specifically, the first latch 46, the first actuator 50, the generally tube-shaped structure 25, and the generally rectangular base 27 are formed as one piece from the flow of the material of the latch portion 26 in the molding operation.

The first latch 46 includes a shaft 54 extending generally in the direction of insertion D. The first latch 46 includes a catch 56 projecting transverse to the direction of insertion D proximate a distal end of the shaft 54. The shaft 54 is configured to flex during insertion into the device (not shown), and the catch 56 is configured to engage a stop surface (not shown) in the device (not shown) to retain the battery pack 10 in the device (not shown).

The first latch 46 is formed from a polymeric material such as plastic (as described above with respect to the housing 14) and includes a latch insert 58 (FIGS. 2, 3, 6, and 7) disposed in the latch arrangement 12, i.e., in at least one of the shaft 54, the catch 56, or the first actuator 50. For example, at least one of the shaft 54, the catch 56, or the first actuator 50 is at least partially molded over the latch insert 58 to form a unitary piece. In the illustrated implementation, the latch insert 58 is disposed in the shaft 54, the catch 56, and the first actuator 50. It should be understood that a second latch insert 58′ is similarly disposed in the second latch 48 and/or the second actuator 52 and need not be described again. The second latch insert 58′ may be a mirror image of the latch insert 58 and, in some implementations (such as that of FIGS. 1-7), may be identical (e.g., if symmetrical).

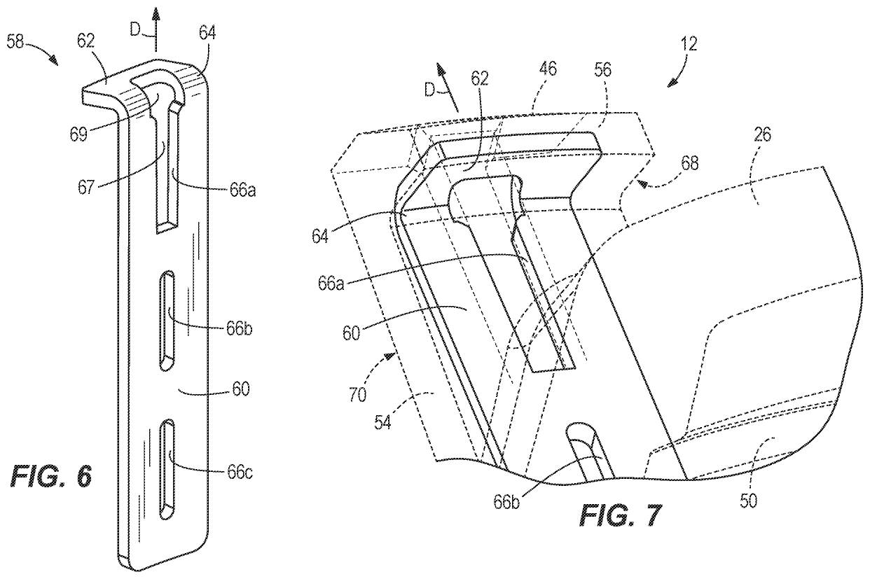

As illustrated in FIG. 6, the latch insert 58 includes a shaft portion 60 and a catch portion 62, each of which is generally planar. In the illustrated implementation of FIG. 6, each of the shaft portion 60 and the catch portion 62 are generally planar in their entirety. The shaft portion 60 extends generally parallel to the shaft 54 of the first latch 46 and, thus, generally parallel to the direction of insertion D. The shaft portion 60 extends at least partially through the shaft 54 of the first latch 46 and further extends at least partially through the first actuator 50. The catch portion 62 is bent with respect to the shaft portion 60 (e.g., by bending, forming, hammering, forging, stamping, or the like) such that the catch portion 62 is transverse to the shaft portion 60. The latch insert 58 may be formed from a single piece of material include a single bend 64 (e.g., no more than one bend, or in other words no more than two generally planar portions disposed transverse to each other), as illustrated (see FIGS. 6-7), or may include two or more bends 64 in other implementations. The catch portion 62 may extend at an approximately right angle with respect to the shaft portion 60, as illustrated, or may extend at any suitable angle with respect to the shaft portion 60, such as about 80-100 degrees, about 70-110 degrees, about 60-120 degrees, etc. The catch portion 62 extends at least partially into or through the catch 56 of the first latch 46. The latch insert 58 is formed from a rigid material, more rigid than the material of the first latch 46 and/or more rigid than the material of the first actuator 50. For example, the latch insert 58 is formed from a metal, or any combination of metals, such as spring steel, carbon steel, stainless steel, aluminum, nickel plated copper, and/or a steel alloy. For example, the steel alloy may use any one of, or combination of one or more of, chromium, nickel, manganese, molybdenum, silicon, tungsten, vanadium, and/or boron as the alloying element.

With reference to FIG. 6, the latch insert 58 includes one or more apertures 66a, 66b, 66c. In the illustrated implementation, the latch insert 58 includes first, second, and third apertures 66a, 66b, 66c; however, one, two, four, or more apertures may be employed in other implementations. In the illustrated implementation, the apertures 66a, 66b, 66c are configured as through-holes through the latch insert 58 and are closed apertures (e.g., not open to the side edges of the latch insert 58); however, in other implementations the apertures 66a, 66b, 66c may include blind holes, slots, recesses, etc. and may be closed or open to the side edges of the latch insert 58, in any combination. In the illustrated implementation, the first aperture 66a is disposed in the shaft portion 60 and the catch portion 62 continuously, thereby extending through the bend 64 in the latch insert 58. The first aperture 66a includes a narrow portion 67 disposed in the shaft portion 60 and a wide portion 69 disposed in the bend 64 and the catch portion 62. The narrow portion 67 is narrower in a direction substantially perpendicular to the direction of insertion D in the plane of the shaft portion 60 than the wide portion 69. The second and third apertures 66b, 66c are each disposed in the shaft portion 60 and each elongated in the direction of insertion D.

The one or more apertures 66a, 66b, 66c reduce the weight of the latch insert 58 and provide increased rigidity. The one or more apertures 66a, 66b, 66c may also provide space for the flow of the material of the first latch 46 and/or the first latch actuator 50 to flow during the molding process to securely couple the latch insert 58 to the material of the first latch 46 and/or the first latch actuator 50. In the illustrated implementation, the second and third apertures 66b, 66c receive the flow of material and the first aperture 66a does not. The first aperture 66a is left open to the environment, though it is recessed from the material of the first latch 46. In other implementations, the first aperture 66a may also receive the flow of material.

As best illustrated in FIGS. 5 and 7, the latch insert 58 may be disposed in the first latch 46 such that no engaging surfaces 68 of the first latch 46, which are configured to engage the device (not shown), include the latch insert 58. In other words, the latch insert 58 is covered by at least the engaging surfaces 68 of the first latch 46 such that the latch insert 58 is not exposed and does not engage the device (not shown). In other implementations, a portion of the latch insert 58 may be exposed through the first latch 46 to provide at least a portion of the engaging surfaces 68 that engage the device (not shown). In the illustrated implementation, as shown in FIG. 5, the latch insert 58 may be partially exposed on some non-engaging surfaces 70 of the second latch 48 (as better illustrated with the second latch insert 58′ in FIG. 5). However, the latch insert 58 may be recessed from the outermost of the non-engaging surfaces 70 as illustrated (as best illustrated with the second latch insert 58′ in FIG. 5). In other implementations, the latch insert 58 may be completely encased in the latch arrangement 12 such that no surface of the latch insert 58 is visible and/or exposed through the latch arrangement 12.

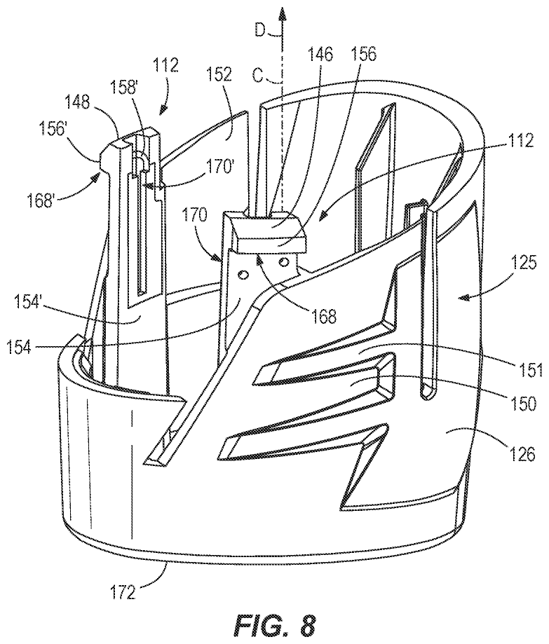

FIGS. 8-10 illustrate another implementation of a latch portion 126 of the housing 14. It should be understood that description of the latch portion 26 above applies to the latch portion 126 except where differences are described below. As such, common description need not be repeated. Like reference numerals plus “100” are used in FIGS. 8-10 and need not be described herein as it should be understood that reference is made to the like reference numerals in the description of the latch portion 26 above.

FIGS. 8-9 illustrate the latch portion 126 having a bottom end cap 172 instead of the generally rectangular base 27. The bottom end cap 172 substantially closes off the generally tube-shaped structure 125 opposite the end cap 38 of the stem portion 22, which is not shown again in FIGS. 8-10 but is employed in the same fashion shown and described above with respect to FIGS. 1-7. Thus, as shown in the implementation of FIGS. 8-10, the battery pack 10 need not include the base portion 24 and the second group of cells 32.

The latch portion 126 includes a latch arrangement 112 having first and second actuators 150, 152 and first and second latches 146, 148 as described above with respect to FIGS. 1-7.

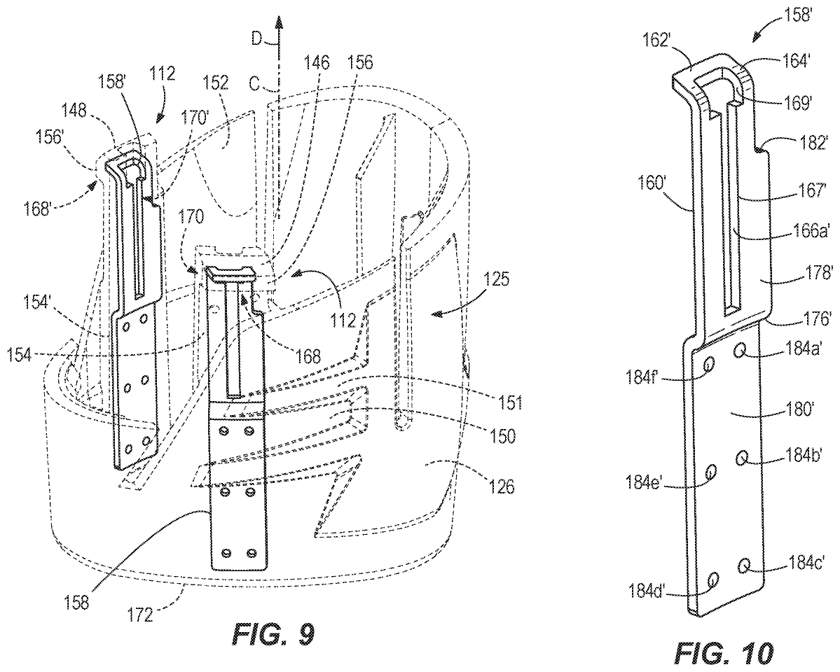

The latch portion 126 includes a first latch insert 158 and a second latch insert 158′. The second latch insert 158′ is shown in greater detail in FIG. 10 and will be described in greater detail below.

The second latch insert 158′ is disposed in the latch arrangement 12, i.e., in at least one of the second shaft 154′, the second catch 156′, or the second actuator 150′. For example, at least one of the second shaft 154′, the second catch 156′, or the second actuator 150′ may be at least partially molded over the second latch insert 158′. In the illustrated implementation, the second latch insert 158′ is disposed in the second shaft 154′, the second catch 156′, and the second actuator 150′. It should be understood that the first latch insert 158 is similarly disposed in the first latch 148 and/or the first actuator 152 and need not be described again. The first latch insert 158 is a mirror image of the second latch insert 158′.

As illustrated in FIG. 10, the second latch insert 158′ includes a shaft portion 160′ and a catch portion 162′. The catch portion 162′ is generally planar. The shaft portion 160′ and the catch portion 162′ are connected by a first bend 164′ in the second latch insert 158′. The shaft portion 160′ includes a second bend 176′ in the second latch insert 158′, wherein the second bend 176′ divides the shaft portion 160′ into a first generally planar portion 178′ and a second generally planar portion 180′ offset from, and generally parallel to, the first generally planar portion 178′. The first and second generally planar portions 178′, 180′ each extend generally parallel to the central axis C and the direction of insertion D.

The first generally planar portion 178′ and the catch portion 162′ include an elongated aperture 166a′ passing through the first bend 174′. In other words, the elongated aperture 166a′ is disposed in the first generally planar portion 178′, the first bend 164′, and the catch portion 162′ continuously. The elongated aperture 166a′ includes a narrow portion 167′ and a wide portion 169′ as described above with respect to FIGS. 1-7. The first generally planar portion 178′ includes a step 182′ that widens the first generally planar portion 178′ in a direction substantially perpendicular to the direction of insertion D in the plane of the generally planar portion 178′.

The second generally planar portion 180′ includes a plurality of apertures 184a′-184f configured to receive a flow of material of the latch arrangement 112 molded therein. Specifically, six apertures 184a′-184f are employed, though one, two, three, four, five, seven, eight, or more apertures may be employed in other implementations. The plurality of apertures 184a′-184f are configured as generally circular through-holes but may have other shapes and structures in other implementations. The plurality of apertures 184a′-184f are arranged in a generally rectangular path in the illustrated implementation but may have other arrangements in other implementations.

Other features, structures, arrangements, dimensions, angles, materials, advantages, alternatives, etc. of the second latch insert 158′ (and thus the first latch insert 158) are the same as the latch insert 58 described herein.

In operation, the user inserts the battery pack 10 into the device receptacle (not shown) in a keyed fashion. During insertion, the first and second latches 46, 48 flex in engagement with the device (not shown) and, upon full insertion, the respective catch 56 engages the stop surface (not shown) in the device (not shown) with a retention force to retain the battery pack 10 in an electrically and mechanically coupled fashion until the user actuates the first and second actuators 50, 52 to remove the battery pack 10. To remove the battery pack 10, the user squeezes the first and second actuators 50, 52 inwardly towards the stem portion 22 to flex the first and second latches 46, 48 and relieve at least some of the retention force between the respective catches and the stop surfaces (not shown) so that the user can pull the battery pack 10 from the receptacle (not shown). The latch inserts 58, 58′ increase the rigidity of the respective latches 46, 48 and/or the respective actuators 50, 52, and add strength to inhibit breakage, fatigue, failure, etc. Thus the latch inserts 58, 58′ reinforce the respective latches 46, 48 and/or the respective actuators 50, 52. In the illustrated implementation, each latch insert 58, 58′ extends from within the respective actuator 50, 52 and through to the respective latch 46, 48 such that the force applied by the user to the respective actuator 50, 52 for releasing the latch is applied to the latch insert 58, 58′ and is transferred through to the respective latch 46, 48 by way of the latch insert 58, 58′, thereby relieving the latch portion 26 of the housing 14 of some stress and fatigue over time.

Operation of the latch arrangement 112 is substantially the same as operation of the latch arrangement 12 described above.

Although the disclosure has been described in detail with reference to preferred implementations, variations and modifications exist within the scope and spirit of one or more independent aspects of the disclosure as described.

Thus the disclosure provides, among other things, a battery pack 10 with a reinforced latch arrangement 12 (or latch arrangement 112).

What is claimed is:

1. A battery pack comprising:
at least one battery cell configured to provide electrical power to a device;
a housing configured to receive the at least one battery cell;
a latch cantilevered on the housing and configured to couple the battery pack to the device;
an actuator configured to move the latch toward a release position in which the latch is configured to release the battery pack from the device; and
a latch insert, wherein at least one of the latch or the actuator is at least partially molded over the latch insert.

2. The battery pack of claim 1, wherein the latch and the actuator are at least partially molded over the latch insert.

3. The battery pack of claim 1, wherein the housing includes a stem portion configured to receive the at least one battery cell and insertable into a receptacle in the device for electrical connection therewith, wherein the housing includes a latch portion, wherein the actuator is cantilevered on the latch portion, wherein the latch is cantilevered from the actuator, and wherein in the release position the actuator is flexed towards the stem portion.

4. The battery pack of claim 3, wherein the actuator includes a grip surface disposed externally and configured for manual actuation by a user.

5. The battery pack of claim 1, wherein the latch includes a shaft and a catch projecting transverse to the shaft, wherein at least one of the shaft or the catch is at least partially molded over the latch insert.

6. The battery pack of claim 5, wherein the latch insert includes a shaft portion disposed in the shaft and a catch portion disposed in the catch.

7. The battery pack of claim 6, wherein the latch insert includes an aperture disposed in at least one of the shaft portion or the catch portion.

8. The battery pack of claim 7, wherein the aperture is disposed in both the shaft portion and the catch portion, through a bend in the latch insert.

9. The battery pack of claim 6, wherein the shaft portion is substantially planar and wherein the catch portion is substantially planar.

10. The battery pack of claim 9, wherein the shaft portion and the catch portion are disposed at a substantially right angle.

11. The battery pack of claim 10, wherein the shaft portion and the catch portion are connected by a single bend in the latch insert.

12. The battery pack of claim 6, wherein the shaft portion and the catch portion are connected by a first bend in the latch insert, and wherein the shaft portion includes a second bend in the latch insert, wherein the second bend divides the shaft portion into a first generally planar portion and a second generally planar portion offset from, and generally parallel to, the first generally planar portion.

13. The battery pack of claim 12, wherein the first generally planar portion and the catch portion include an elongated aperture passing through the first bend, and wherein the second generally planar portion includes a plurality of apertures configured to receive a flow of material molded therein.

14. The battery pack of claim 1, wherein the latch insert is formed from a rigid material and is more rigid than a material of the latch and/or more rigid than a material of the actuator.

15. The battery pack of claim 1, wherein the actuator and the latch are formed as one piece from a flow of material in a molding operation.

16. The battery pack of claim 15, wherein the actuator and the latch are formed from a polymeric material and the latch insert is formed from a metal.

17. A battery pack comprising:
a plurality of battery cells configured to provide electrical power to a device;
a housing configured to receive the plurality of battery cells;
a latch configured to flex to couple the battery pack to the device;
an actuator configured to move the latch toward a release position in which the latch is configured to release the battery pack from the device, the actuator cantilevered on the housing, the latch cantilevered from the actuator; and
a latch insert, wherein at least one of the latch or the actuator is at least partially molded over the latch insert.

18. The battery pack of claim 17, wherein the actuator and the latch are formed as one piece from a flow of material in a molding operation.

19. A battery pack comprising:
a plurality of battery cells configured to provide electrical power to a device;
a housing configured to receive the plurality of battery cells;
a latch configured to flex to couple the battery pack to the device;
an actuator configured to move the latch toward a release position in which the latch is configured to release the battery pack from the device, the actuator cantilevered on the housing, the latch cantilevered from the actuator, the actuator and the latch being formed as one piece from a flow of material in a molding operation; and
a latch insert, wherein at least one of the latch or the actuator is at least partially molded over the latch insert, and wherein the latch insert is formed from a rigid material and is more rigid than the material of the latch and the actuator.

20. The battery pack of claim 19, wherein the latch includes a shaft extending generally in a direction of insertion of the battery pack into the device and a catch projecting from the shaft transverse to the direction of insertion proximate a distal end of the shaft, wherein the latch insert is disposed in the shaft and the catch.
